(19) United States
(12) Patent Application Publication
(10) Pub. No.: US 2024/0275291 A1
(43) Pub. Date: Aug. 15, 2024

(54) THREE-LEVEL ZETA ASYMMETRICAL HALF-BRIDGE

(71) Applicant: Hamilton Sundstrand Corporation, Charlotte, NC (US)

(72) Inventors: Douglas Araujo Pedroso, Cork (IE); Ignacio Castro Álvarez, Gijón (ES)

(73) Assignee: Hamilton Sundstrand Corporation, Charlotte, NC (US)

(21) Appl. No.: 18/394,286

(22) Filed: Dec. 22, 2023

(30) Foreign Application Priority Data
Feb. 14, 2023 (EP) 23156581.3

(51) Int. Cl. H02M 3/335; H02M 3/00

(52) U.S. Cl. CPC H02M 3/33571; H02M 3/01

(57) ABSTRACT

A three-level zeta asymmetrical half-bridge for converting a DC input voltage into a DC output voltage comprising an asymmetrical half-bridge, a resonant tank and a zeta converter.

### CROSS-REFERENCE TO RELATED APPLICATIONS

This application claims priority to and the benefit of European Patent Application No. 23156581.3, filed Feb. 14, 2023, the entire content of which is incorporated herein by reference.

### TECHNICAL FIELD

This disclosure relates to multilevel series resonant DC to DC voltage converters, in particular to a three-level zeta asymmetrical half-bridge.

### BACKGROUND

In various DC to DC voltage applications, it may be important to isolate the high voltage part of the circuit from the low voltage part of the circuit. In addition, there are often large variations in either the input or output voltage. Various topologies of existing DC to DC voltage converters require a high degree of complexity of control of the circuit and/or have complex input EMI filtering requirements. Furthermore, reducing the voltage stresses across components may allow smaller components to be used in many applications. It is an aim to reduce losses in DC to DC power conversion, to reduce cooling requirements of the circuit, and/or to prolong the lifetime of circuit components.

### SUMMARY

When viewed from a first aspect, the present disclosure provides a three-level zeta asymmetrical half-bridge for converting a DC input voltage into a DC output voltage comprising: an asymmetrical half-bridge, comprising a first pair of switching elements, and a second pair of switching elements in series with the first pair of switching elements; wherein a first portion of the DC input voltage is applied in parallel with the first pair of switching elements, and a second portion of the DC input voltage is applied in parallel with the second pair of switching elements; a resonant tank in parallel with one switching element from each pair of switching elements, the resonant tank comprising a magnetising inductance of a primary winding of a transformer, a resonant inductance and a primary resonant capacitance; and a zeta converter connected to a secondary winding of the transformer; wherein each pair of switching elements is arranged to operate in a sequence to selectively connect and disconnect the resonant tank to the respective first or second portion of the DC input voltage, such that a voltage of the resonant tank alternates between a low voltage and a high voltage; and wherein the resonant tank is arranged to filter out a DC component of the voltage of the resonant tank and output a filtered resonant tank voltage to the primary winding of the transformer; and wherein the zeta converter is arranged to rectify the output of the secondary winding of the transformer to output the DC output voltage.

A two-level half-bridge may be defined as a circuit in which two switches are connected in series with a power supply. Alternately switching on one switch and off the other switch applies the power supply voltage across the open, i.e. off, switch. Switching on and off each switch alternately applies the power supply voltage across each switch. An asymmetrical half-bridge may be defined as two switches connected in series with a power supply, wherein the load on each switch, i.e. in parallel with each switch, is not equal, i.e. not symmetric.

A three-level asymmetrical half bridge may be defined as two two-level asymmetrical half-bridges in series with each other, wherein a load is applied across the outputs of one of the two switches of each two-level asymmetrical half-bridge. By applying either no voltage across the load, the voltage of one of the two power supplies, or the voltage of both power supplies, the voltage across the load may be varied between three voltage levels.

A resonant tank may be defined as a circuit made up of at least one inductor, and at least one capacitor, that resonates at a specific frequency, called the resonant frequency.

A zeta converter may be defined as an DC-DC voltage converter. A traditional zeta converter has an input voltage applied across an inductor, wherein the inductor is in series with a capacitor, and wherein the output of the capacitor is in series with two parallel branches. The first branch comprises a diode arranged to only allow the flow of current toward the capacitor, and the second branch comprising an inductor and a second capacitor in series. A load is applied across, i.e. in parallel, with the second capacitor.

Use of a transformer in the three-level zeta asymmetrical half-bridge provides galvanic isolation between the input and output of the circuit.

A three-level zeta asymmetrical half-bridge may be defined as a three-level asymmetrical half bridge which outputs to a resonant tank, comprising the first winding of a transformer, wherein the second winding of the transformer is the input to a zeta converter, and wherein the zeta converter outputs an output voltage to a load. The three-level zeta asymmetrical half-bridge comprises each of the asymmetrical half-bridge, the resonant tank, the transformer, and the zeta converter.

In some examples, the switching elements comprise a switch, a (e.g. parasitic) diode and a (e.g. parasitic) capacitance in parallel; and optionally wherein the switching elements are each arranged to switch on when the voltage across the respective switching element is zero.

In some examples, the first pair of switching elements and the second pair of switching elements are arranged to operate in phase, to alternate the voltage applied to the resonant tank between the DC input voltage and ground.

In phase may be defined as each pair of switching elements applying a high voltage and a low voltage to the resonant tank at the same times, by switching the first switching element (e.g. main switching element) from each pair of switching elements on at the same time, and off at the same time. In phase may also be defined as switching the second switching element (e.g. complementary switching element) from each pair of switching elements on at the same time and off at the same time.

In some examples, the first portion and the second portion of the DC input voltage is equal to half the DC input voltage. In various examples, this may enable the converter to apply a constant, rather than variable, output voltage to the load.

In some examples, the DC input voltage is split across a first capacitor, across which the first portion of the DC input voltage is applied, and a second capacitor, across which the second portion of the DC input voltage is applied; wherein the first capacitor is in series with the second capacitor.

In some examples, the first pair of switching elements and the second pair of switching elements are arranged to operate out of phase.

Out of phase may be defined as the timing of switching of the first switching element from each pair of switching elements being different, i.e. they do not both switch on at the same time, or off at the same time, but one may switch on at the same time that the other switches off. The same is true for the second switching elements from each pair of switching elements.

In some examples, the first pair of switching elements and the second pair of switching elements are arranged to operate out of phase to alternate the voltage applied to the resonant tank between half the DC input voltage and ground.

In some examples, the first pair of switching elements and the second pair of switching elements are arranged to operate out of phase to alternate the voltage applied to the resonant tank between the DC input voltage and half the DC input voltage.

In some examples, the zeta converter comprises: a secondary resonant capacitance in series with the secondary winding of the transformer; a rectifying diode in series with the secondary winding of the transformer; an output inductor in series with the secondary resonant capacitance and in parallel with the rectifying diode; an output capacitor in series with the output inductor; and wherein the DC output voltage is applied to a load in parallel with the output capacitor and in series with the output inductor.

In some examples, the zeta converter comprises: a rectifying switching element comprising a switch and a diode in parallel, wherein the rectifying switching element is in series with the secondary winding of the transformer; an output inductor in series with the secondary resonant capacitance and in parallel with the rectifying switching element; an output capacitor in series with the output inductor; and wherein the DC output voltage is applied to a load in parallel with the output capacitor and in series with the output inductor.

In some examples, the rectifying switching element is a MOSFET with an integrated (e.g. parasitic) body diode and switch.

In some examples, the transformer is a tapped transformer; and wherein the zeta converter comprises: a rectifying diode in series with the secondary winding of the transformer; an output inductor connected part-way along the secondary winding of the transformer; an output capacitor in series with the output inductor; wherein the DC output voltage is applied to a load in parallel with the output capacitor and in series with the output inductor; and wherein the zeta converter further comprises a secondary resonant capacitance in series with each of the secondary winding of the transformer, the rectifying diode, and the output inductor.

A tapped transformer may be defined as a transformer wherein the secondary winding of the transformer has an additional output part-way along the length of the secondary transformer winding.

In some examples, the transformer is a centre tapped transformer, i.e. the transformer is tapped at the centre.

In some examples, the transformer is a tapped transformer; and wherein the zeta converter comprises: a rectifying switching element comprising a switch and a diode in parallel, wherein the active rectifying switching element is in series with the secondary winding of the transformer; an output inductor connected part-way along the secondary winding of the transformer; an output capacitor in series with the output inductor; wherein the DC output voltage is applied to a load in parallel with the output capacitor and in series with the output inductor; and wherein the zeta converter further comprises a secondary resonant capacitance in series with each of the secondary winding of the transformer, the rectifying switching element, and the output inductor.

In various examples, any switching elements using actively controlled power semiconductor technology may be used. In various examples, instead of MOSFETs any of IGBTs, HEMTs or bidirectional switches are used as alternatives, or in combination with MOSFETs. In some examples, the rectifying switching element is a MOSFET with an integrated body diode and switch.

In some examples, the transformer is a step-down transformer. In some examples, the transformer is a step-up transformer. In some examples, the transformer is a one to one transformer.

In some examples, the primary resonant inductance is the leakage inductance of the primary winding of the transformer.

In some examples, the switching elements are arranged to alternate the voltage of the resonant tank between the low voltage and the high voltage at a fixed frequency.

In some examples, a proportion of time that the voltage applied to the resonant tank is a high voltage may be varied.

In some examples, the switching elements are arranged to operate to generate a square wave to the resonant tank such that the voltage of the resonant tank is a square wave.

When viewed from a second aspect, the present disclosure provides a method of operating a three-level zeta asymmetrical half-bridge (e.g. according to any of the examples herein) to convert a DC input voltage into a DC output voltage, wherein the three-level zeta asymmetrical half-bridge comprises:
an asymmetrical half-bridge, comprising a first pair of switching elements, and a second pair of switching elements in series with the first pair of switching elements;
a resonant tank in parallel with one switching element from each pair of switching elements, the resonant tank comprising a magnetising inductance of a primary winding of a transformer, a resonant inductance and a primary resonant capacitance; and
a zeta converter connected to a secondary winding of the transformer; the method comprising:
applying a first portion of the DC input voltage in parallel with the first pair of switching elements;
applying a second portion of the DC input voltage in parallel with the second pair of switching elements;
operating each pair of switching elements in a sequence to selectively connect and disconnect the resonant tank to the respective first or second portion of the DC input voltage, such that a voltage of the resonant tank alternates between a low voltage and a high voltage;
the resonant tank filtering out a DC component of the voltage of the resonant tank and outputting a filtered resonant tank voltage to the primary winding of the transformer; and
the zeta converter rectifying the output of the secondary winding of the transformer to output the DC output voltage.

In some examples, the method further comprises switching the switching elements on when the voltage across the respective switching element is zero.

In some examples, the method further comprises operating first pair of switching elements and the second pair of switching elements in phase to alternate the voltage applied to the resonant tank between the DC input voltage and ground.

In some examples, the method further comprises splitting the DC input voltage across a first capacitor, across which the first portion of the DC input voltage is applied, and a second capacitor, across which the second portion of the DC input voltage is applied.

In some examples, the method further comprises operating the first pair of switching elements and the second pair of switching elements out of phase to alternate the voltage applied to the resonant tank between half the DC input voltage and ground.

In some examples, the method further comprises operating the first pair of switching elements and the second pair of switching elements out of phase to alternate the voltage applied to the resonant tank between the DC input voltage and half the DC input voltage.

In some examples, the method further comprises operating the switching elements to alternate the voltage of the resonant tank between the low voltage and the high voltage at a fixed frequency.

In some examples, the method further comprises operating the switching elements to alternate the voltage of the resonant tank between the low voltage and the high voltage, and a proportion of time that the voltage applied to the resonant tank is a high voltage may be varied.

In some examples, the method further comprises operating the switching elements to generate a square wave to the resonant tank, such that the voltage of the resonant tank is a square wave.

### BRIEF DESCRIPTION OF DRAWINGS

One or more non-limiting examples will now be described, by way of example only, and with reference to the accompanying figures in which:

FIG. 1 shows a two-level zeta asymmetrical half-bridge;

FIG. 2 shows a three-level zeta asymmetrical half-bridge according to the present disclosure;

FIGS. 3a to 3f show different operating states of the three-level zeta asymmetrical half-bridge of FIG. 2 during mode 3 operation;

FIG. 4 shows waveforms of voltages and currents during the mode 3 operation of FIGS. 3a to 3f;

FIGS. 5a to 5k show different operating states of the three-level zeta asymmetrical half-bridge of FIG. 2 during mode 1 operation;

FIG. 6 shows waveforms of voltages and currents during the mode 1 operation of FIGS. 5a to 5k;

FIGS. 7a to 7k show different operating states of the three-level zeta asymmetrical half-bridge of FIG. 2 during mode 2 operation;

FIG. 8 shows waveforms of voltages and currents during the mode 2 operation of FIGS. 7a to 7k;

FIG. 9a shows the relationship between duty cycle and tank voltage to output voltage gain for each of a traditional asymmetrical half-bridge, a two-level zeta asymmetrical half-bridge and a three-level zeta asymmetrical half-bridge, each using a 1:1 transformer and operating at a given switching frequency of the switching elements;

FIG. 9b shows the relationship between duty cycle and static gain for each of a traditional asymmetrical half-bridge, a two-level zeta asymmetrical half-bridge and a three-level zeta asymmetrical half-bridge, each using a 1:1 transformer and operating at a given switching frequency of the switching elements;

FIG. 10a shows a three-level zeta asymmetrical half-bridge according to the present disclosure, with active rectification;

FIG. 10b shows a three-level zeta asymmetrical half-bridge according to the present disclosure, with a tapped-transformer; and

FIG. 10c shows a three-level zeta asymmetrical half-bridge according to the present disclosure, with active rectification and a tapped transformer.

### DETAILED DESCRIPTION

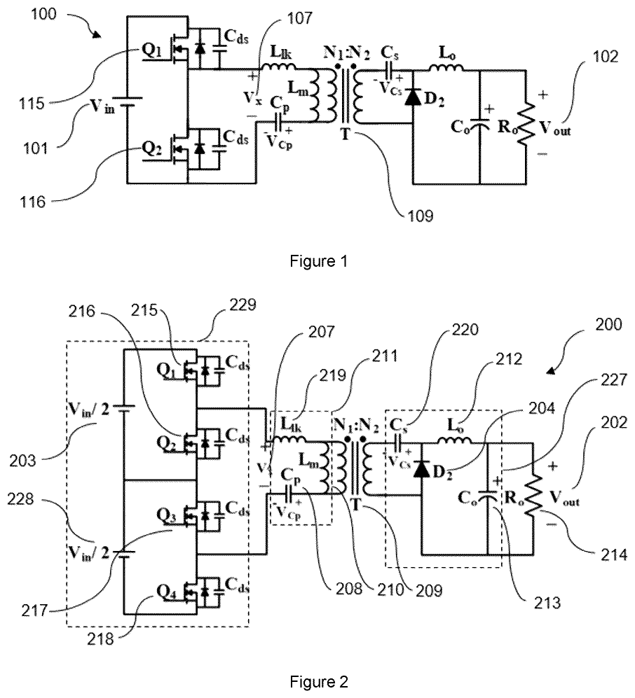

Referring to FIG. 1, a two-level zeta asymmetrical half-bridge 100 converts a DC input voltage Vᵢₙ 101 to a DC output voltage Vₒᵤₜ 102.

The two-level zeta asymmetrical half-bridge 100 operates by switching MOSFETs Q₁ 115 and Q₂ 116 to alternate the tank voltage Vₓ 107 between either zero or the input voltage Vᵢₙ.

The transformer 109 is configured as either a step up or step down transformer, depending on the turns ratio between the primary and secondary windings of the transformer 109.

The input side of the transformer 109 is an asymmetrical half-bridge and the output is the same as that of a zeta converter. This design is known as a two-level zeta asymmetrical half bridge 100, as the circuit is designed to alternate the tank voltage Vₓ 107 between two voltage levels, zero or the input voltage Vᵢₙ 101.

Referring to FIG. 2, a three-level zeta asymmetrical half-bridge 200, according to the present disclosure converts an input voltage Vᵢₙ to an output voltage Vₒᵤₜ 202.

FIG. 2 shows the input voltage split equally into a first input 203 and a second input 228, each of half the input voltage Vᵢₙ/2. While in this example, both inputs 203, 228 are equal to half the input voltage Vᵢₙ/2, it will be appreciated that each input 203, 228 is not required to be the same value, i.e. the input voltage Vᵢₙ could be split unequally. However, splitting the voltage equally helps to balance the voltage stress over each of the first and second pairs of switching elements and may help to ensure a constant current is applied to the load.

The three-level zeta asymmetric half-bridge 200 has a resonant tank 211. The resonant tank comprises a resonant inductance, which is the leakage inductance of the transformer Lₗₖ 219 a primary resonant capacitance Cₚ 208; and a magnetising inductance Lₘ 210 of the transformer 209. The voltage applied to the resonant tank 211 is the tank voltage Vₓ 207. In operation, this tank voltage is a square wave that varies between a high voltage and a low voltage at a fixed frequency. The role of the resonant tank 211 is to filter out the DC component of the tank voltage Vₓ 207, outputting only the AC square waveform of the tank voltage Vₓ 207 to the input of the transformer 209. Using a resonant tank helps to enable the circuit to operate using soft switching, i.e. zero-voltage and/or zero-current switching.

The transformer 209 has a turns ratio N1:N2 between the primary, input, winding and secondary, output, winding.

The output of the transformer 209 is the input of a zeta converter 227. The zeta converter 227 has a secondary resonant capacitance Cₛ 220; a diode D₂ 204; an inductor Lₒ 212 and a capacitor Cₒ 213. The zeta converter 227 converts the AC output of the transformer 209 into a DC voltage Vₒᵤₜ 202. The output Vₒᵤₜ 202 of the zeta converter 227 is applied to a load Rₒ 214. Using a zeta converter helps to simplify the control of the circuit, due to a linear static gain and tank to output voltage gain. Various examples of zeta converters may be used with this disclosure.

The three-level zeta asymmetrical half-bridge 200 has an asymmetrical half-bridge 229 made up of a plurality of switching elements Q₁ 215, Q₂ 216, Q₃ 217 and Q₄ 218. In this example, each switching element 215, 216, 217, 218 is a MOSFET with an integrated body diode and a parasitic drain source capacitance C_{ds}. However, in various examples it will be apparent that other switching elements are possible, and therefore a MOSFET does not need to be used. In various examples, any switching elements using actively controlled power semiconductor technology may be used. In various examples, instead of MOSFETs any of IGBTs, HEMTs or bidirectional switches may be used as alternatives, or in combination with MOSFETs. This arrangement helps to enable soft switching to be used in the switch on operations of the switching elements.

In this example, the first input voltage 203 is split across a first pair of switching elements Q₁ 215 and Q₂ 216. The second input voltage 228 is split across a second pair of switching elements Q₃ 217 and Q₄ 218. Each pair has a first switching element, Q₁ 215 and Q₄ 218 respectively, and a second switching element, Q₂ 215 and Q₃ 216 respectively. The tank voltage Vₓ 207 is the sum of the voltage across the second switching element of the pair, Q₂ 215 and Q₃ 216, of each pair of switching elements, Q₁ 215 and Q₂ 216, and Q₃ 217 and Q₄ 218.

The asymmetrical half-bridge 229 operates by switching the switching elements Q₁ 215, Q₂ 216, Q₃, 217 and Q₄ 218 in any one of three predetermined sequences, each corresponding to one of three modes of operation. In each mode of operation, the tank voltage Vₓ 207 is a square wave switching at a fixed frequency between a high voltage and a low voltage. Hence, in this example, fixed frequency pulse width modulation is preferably used. While the voltage switching frequency is fixed, the duty cycle may be varied and this enables the circuit to convert a wide range of input voltages to a specific output voltage. Therefore, the three-level zeta asymmetrical half-bridge 200 has an advantage over a traditional LLC resonant converter which has to operate with high frequency variation over a wide input voltage range. Fixed frequency operation significantly simplifies the EMI filtering required at the input to the three-level zeta asymmetrical half-bridge 200.

In mode 1 operation, the tank voltage Vₓ 207 alternates between zero and half the input voltage Vᵢₙ/2. In mode 2 operation, the tank voltage Vₓ 207 alternates between half the input voltage Vᵢₙ/2 and the input voltage Vᵢₙ. In mode 3 operation, the tank voltage Vₓ 207 alternates between zero and the input voltage Vᵢₙ. Hence, this circuit is known as a three-level zeta asymmetrical half-bridge due to the three possible voltage levels of the tank voltage Vₓ 207.

Mode 1, mode 2 and mode 3 operation of the three-level zeta asymmetrical half-bridge 200 will be outlined below with reference to additional figures. Mode 3 operation of the three-level zeta asymmetrical half-bridge 200 is analogous with operation of the two-level zeta asymmetrical half-bridge 100 and will be described first. Various benefits of the three-level zeta asymmetrical half-bridge 200 over the two-level zeta asymmetrical half-bridge 100, even in mode 3 operation, will be discussed.

Modes 1 and 2 of operation of the three-level zeta asymmetrical half-bridge 200 are novel over the two-level zeta asymmetrical half bridge 100 and have additional advantages over it, which will also be discussed in more detail.

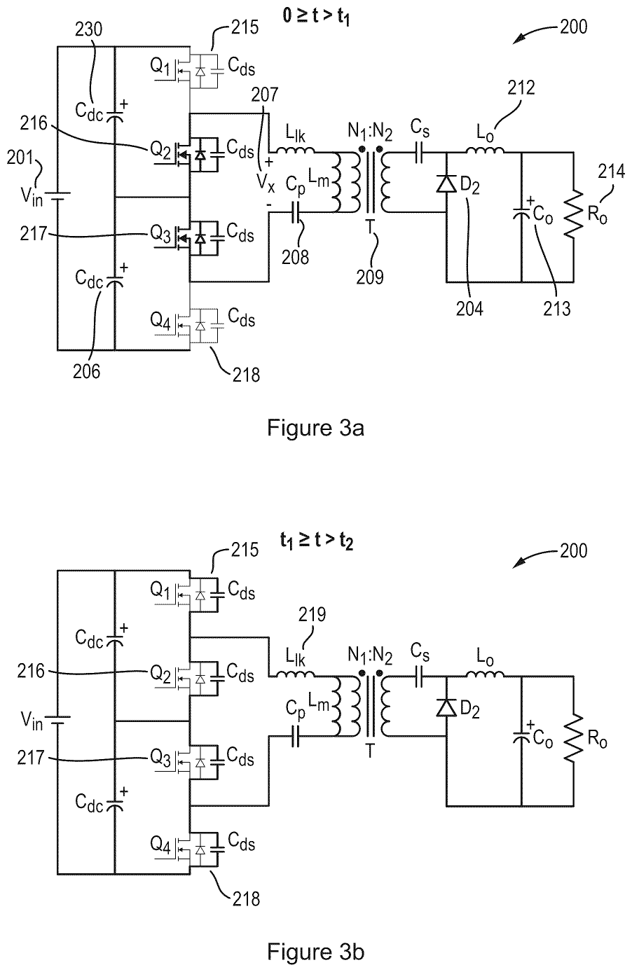

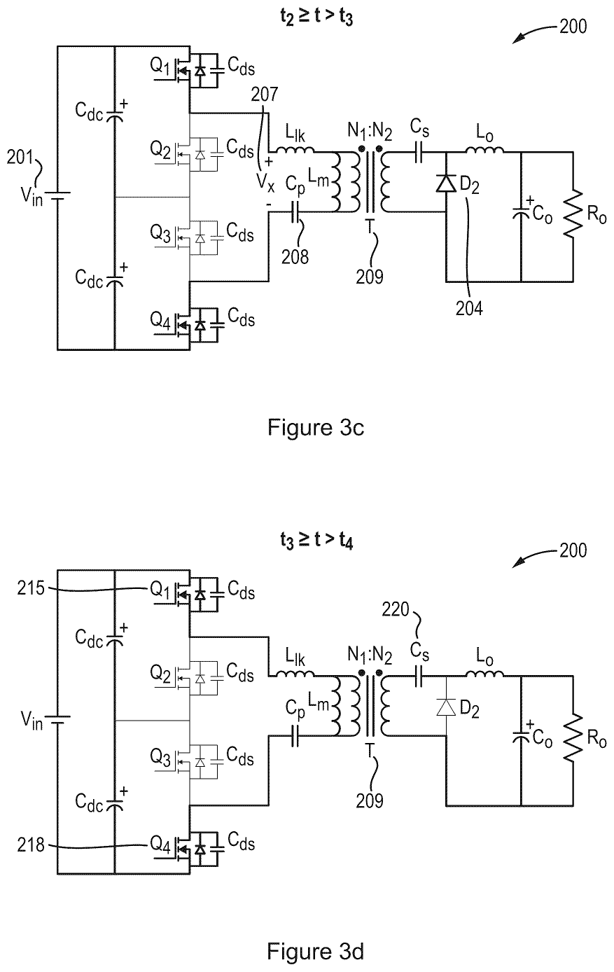

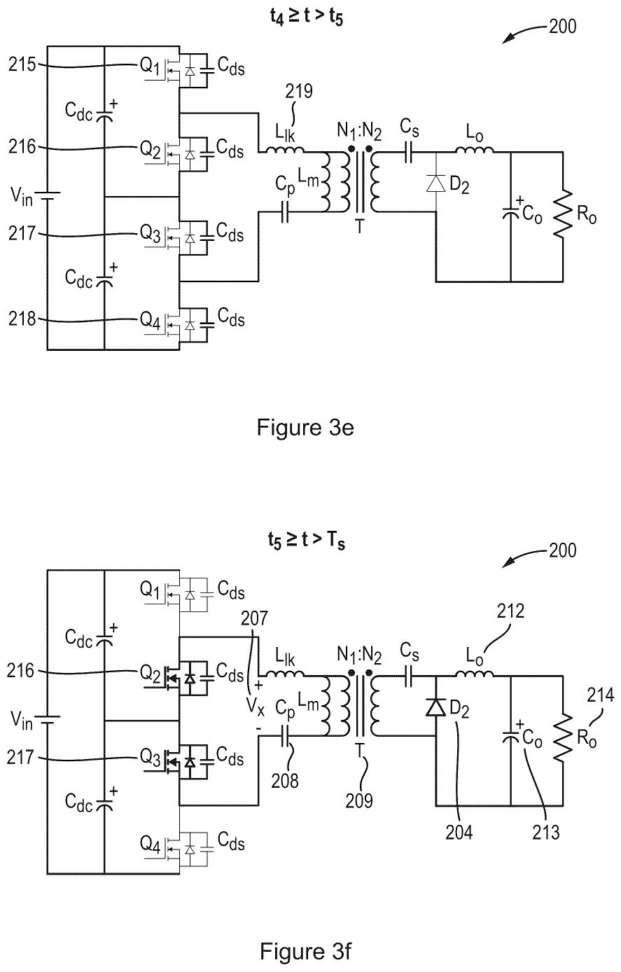

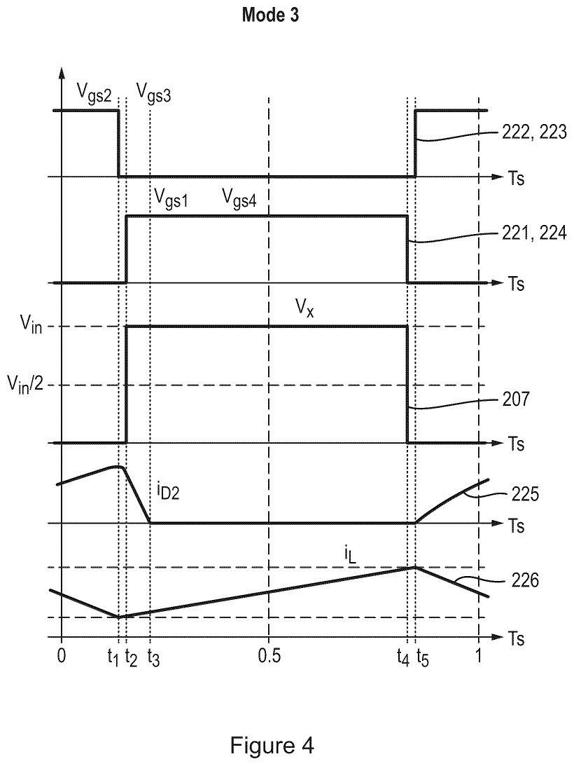

Referring to FIGS. 3a to 3f and FIG. 4, a mode of operation of the three-level zeta asymmetrical half-bridge 200 of FIG. 2 is shown. The shaded elements in FIGS. 3a to 3f indicate no conduction. The mode of operation outlined in FIGS. 3a to 3f and FIG. 4 is referred to as mode 3. In FIGS. 3a to 3f, the input voltage Vᵢₙ 201 is split evenly between a first capacitor 206 and a second capacitor 230. The voltage of the capacitors 206, 230 corresponds to the input voltages Vᵢₙ/2 203, 228 of FIG. 2.

Referring to FIG. 4, waveforms are shown between t₀ and Tₛ for mode 3 operation, as described in FIGS. 3a to 3f, of the three-level zeta asymmetrical half-bridge 200 of FIG. 2. The waveforms shown represent the gate-source voltage 222 of the switching element Q₂ 216; the gate-source voltage 221 of the switching element Q₁ 215; the tank voltage Vₓ 207; the current 225 through the diode D₂ 204; and the current 226 through the inductor Lₒ 212. The current 226 is filtered by the capacitor Cₒ 213 such that, ideally, a constant current is provided to the load Rₒ.

In mode 3 operation, the gate-source voltage 222 of the switching element Q₂ 216 is the same as the gate-source voltage 223 of the switching element Q₃ 217. In mode 3 operation, the gate-source voltage 221 of the switching element Q₁ 215 is the same as the gate-source voltage 224 of the switching element Q₄ 218.

Between times t₀ and t₁, as shown in FIG. 3a and FIG. 4, the tank voltage Vₓ 207 is equal to zero. V_{cp}, the voltage across the primary resonant capacitance Cₚ 208, is applied to the primary winding of the transformer 209. The current 225 through the diode D₂ 204 increases as the inductor Lₒ 212 and the capacitor Cₒ 213 supply energy to the load Rₒ 214. This time interval ends when the switching elements Q₂ 216 and Q₃ 217 are switched off at time t₁.

Between times t₁ and t₂, as shown in FIG. 3b and FIG. 4, the resonant current through the transformer Lₗₖ 219 starts to charge the drain source capacitances of the switching elements Q₂ 216 and Q₃ 217 to half the input voltage Vᵢₙ/2; and discharge the drain source capacitances of the switching elements Q₁ 215 and Q₄ 218 to zero. Before time t₂, the voltages 221, 224 over the switching elements Q₁ 215 and Q₄ 218 reach zero, and their body diodes will start conducting, thus clamping the switching elements Q₂ 216 and Q₃ 217 at half the input voltage Vᵢₙ/2. At time t₂ the switching elements Q₁ 215 and Q₄ 218 are switched on.

As there is no voltage 221, 224 across the switching elements Q₁ 215 or Q₄ 218 when they are switched on, this is a first example of zero voltage switching, which is used several times in the operation of the three-level zeta asymmetrical half-bridge 200. There are various benefits of zero voltage switching, including that it minimises any voltage or power loss over the switching elements of the circuit and minimises the EMI effects of switching. Further benefits include minimising the temperature increase corresponding to power loss in the switching elements, thereby reducing the cooling requirements of the circuit and prolonging the life of the device.

Between times t₂ and t₃, as shown in FIG. 3c and FIG. 4, the tank voltage Vₓ 207 is equal to the input voltage Vᵢₙ 201. The voltage applied to the primary winding of the transformer 209 is the tank voltage Vₓ 207 minus the voltage V_{cp}, the voltage across the primary resonant capacitance Cₚ 208. The current 225 through the diode D₂ 204 starts to decrease. At time t₃, the current 225 through the diode D₂ 204 is zero and so the diode D₂ 204 is blocked.

Between times t₃ and t₄, as shown in FIG. 3d and FIG. 4, the output is still charged by the secondary winding of the transformer 209 and the secondary resonant capacitance Cₛ 220. At time t₄, the switching elements Q₁ 215 and Q₄ 218 are turned off, thus starting the dead-time period to ensure zero voltage switching operation. Dead-time may be defined as the sufficient time to guarantee safe switching in a power converter.

Between times t₄ and t₅, as shown in FIG. 3e and FIG. 4, the resonant current through the transformer Lₗₖ 219 starts to charge the drain source capacitances of the switching elements Q₁ 215 and Q₄ 218 to half the input voltage Vᵢₙ/2; and discharge the drain source capacitances of the switching elements Q₂ 216 and Q₃ 217 to zero. Before time t₅, the voltages 222, 223 over the switching elements Q₂ 216 and Q₃ 217 will reach zero, and their body diodes will start conducting, thus clamping the switching elements Q₁ 215 and Q₄ 218 at half the input voltage Vᵢₙ/2. At t₅ the switching elements Q₂ 216 and Q₃ 217 switch on, again using zero voltage switching.

Between times t₅ and T₈, as shown in FIG. 3f and FIG. 4, the tank voltage Vₓ 207 is equal to zero. The voltage V_{cp}, the voltage across the primary resonant capacitance Cₚ 208, is applied to the primary winding of the transformer 209. The current 225 through the diode D₂ 204 increases as the inductor Lₒ 212 and the capacitor Cₒ 213 supply energy to the load Rₒ 214. At this point, the circuit state is equal to the interval from t₀ to t₁.

Referring to FIG. 1, FIG. 2, FIGS. 3a to 3f, and FIG. 4; mode 3 operation of the three-level zeta asymmetric half-bridge 200 is analogous with operation of the two-level zeta half-bridge 100. The switching elements Q₁ 215 and Q₄ 218 of the three-level zeta asymmetric half-bridge 200 operate analogously to the switching element Q₁ 115 of the two-level zeta asymmetric half-bridge 100; and the switching elements Q₂ 216 and Q₃ 217 of the three-level zeta asymmetric half-bridge 200 operate analogously to the switching element Q₂ 116 of the two-level zeta asymmetric half-bridge 100.

However, as the input voltage 201 to the three-level zeta asymmetric half-bridge 200 is split, when compared with an equivalent two-level zeta asymmetrical half-bridge 100 the three-level zeta asymmetrical half-bridge 200 at the same voltage switching frequency may be able to use smaller passive components and may have reduced voltage stress over the semiconductors. This may result in improvements in power density and specific power, despite the increased number of active components required. In other words, the voltages across the switching elements Q₁ to Q₄ 215, 216, 217, 218 in the three-level zeta asymmetrical half-bridge 200 is half the voltage across the switching elements Q₁ 115 and Q₂ 116 in the corresponding two-level zeta asymmetrical half bridge 100. This also reduces in a reduction of the associated cooling requirements.

In addition, the three-level zeta asymmetrical half-bridge 200 offers two additional modes of operation, modes 1 and 2. In these modes, the MOSFETs Q₁ 215 and Q₂ 216 are operated as a pair and the MOSFETs Q₃ 217 and Q₄ 218 operate as a pair. The first pair of MOSFETs 215 and 216 operates out of phase with the second pair of MOSFETs 217 and 218, which results in the tank voltage Vₓ 207 switching at twice the switching frequency of the MOSFETs 215, 216, 217, 218. Therefore, in modes 1 and 2 operation, half the amplitude of variation of the tank voltage Vₓ 207 results in the same power transfer as an equivalent two-level zeta asymmetrical half-bridge 100. In mode 1 operation, the voltage varies between zero and half the input voltage Vᵢₙ/2; while in mode 2 operation the voltage varies between half the input voltage Vᵢₙ/2 and the input voltage Vᵢₙ.

As a result of the reduction in the amplitude of the variation of the tank voltage Vₓ 207; when compared with an equivalent two-level zeta asymmetric half-bridge 100, a three-level zeta asymmetrical half-bridge 200 in modes 1 and 2 of operation may have beneficial transformer 209 properties. For example when the three-level zeta asymmetrical half-bridge 200 is used in step-down applications, compared with an equivalent two-level zeta-asymmetrical half-bridge 100 it may be able to use a smaller transformer 209, with half the turns ratio.

Alternatively, a transformer 209 with the same turns ratio may be used, and in this case the three-level zeta asymmetrical half-bridge 200 in modes 1 and 2 of operation will only need to operate the switching elements Q₁ 215, Q₂ 216, Q₃, and Q₄ at half the switching frequency. This may lead to a significant reduction in switching losses. A compromise between the benefits in transformer 209 size and switching frequency may be determined during the circuit design. Modes 1 and 2 will be described in more detail with reference to additional figures below. Various of these benefits also apply to step-up applications and one to one DC to DC conversion.

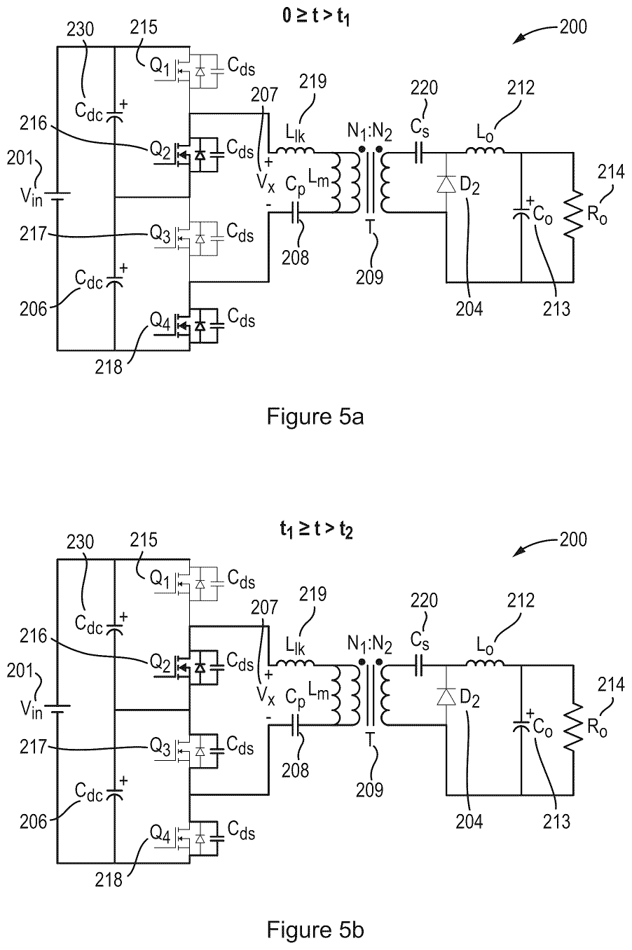

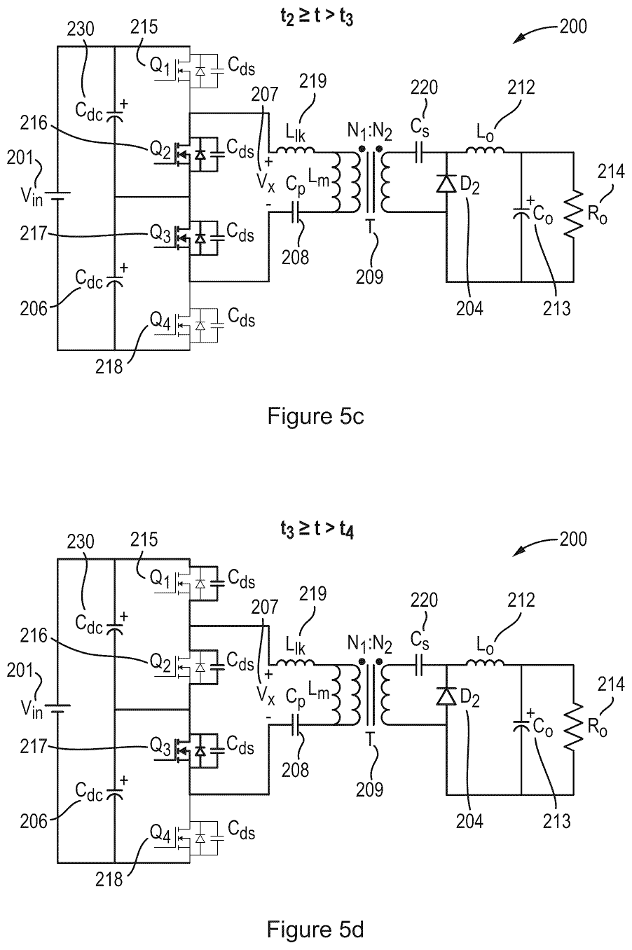

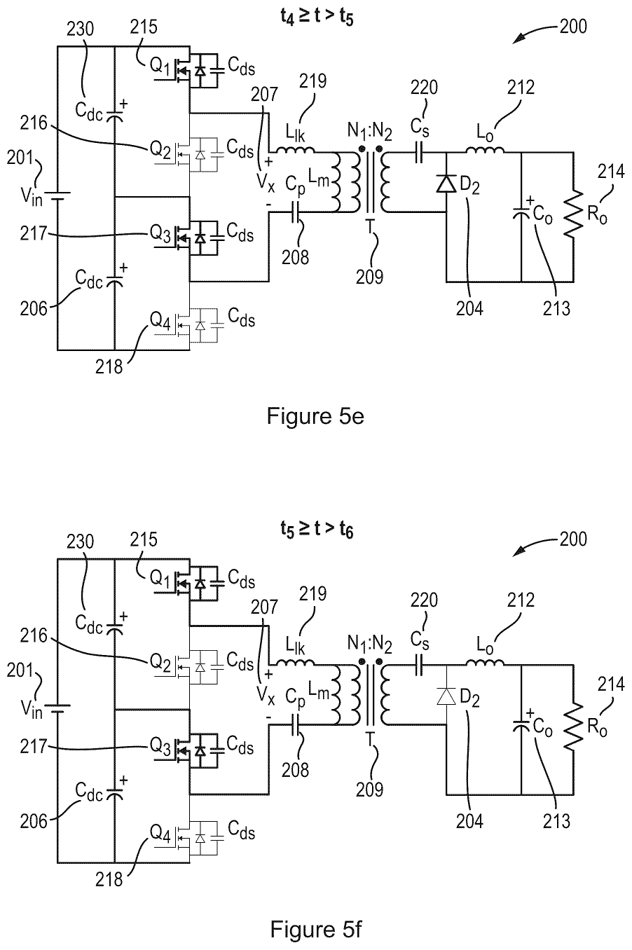

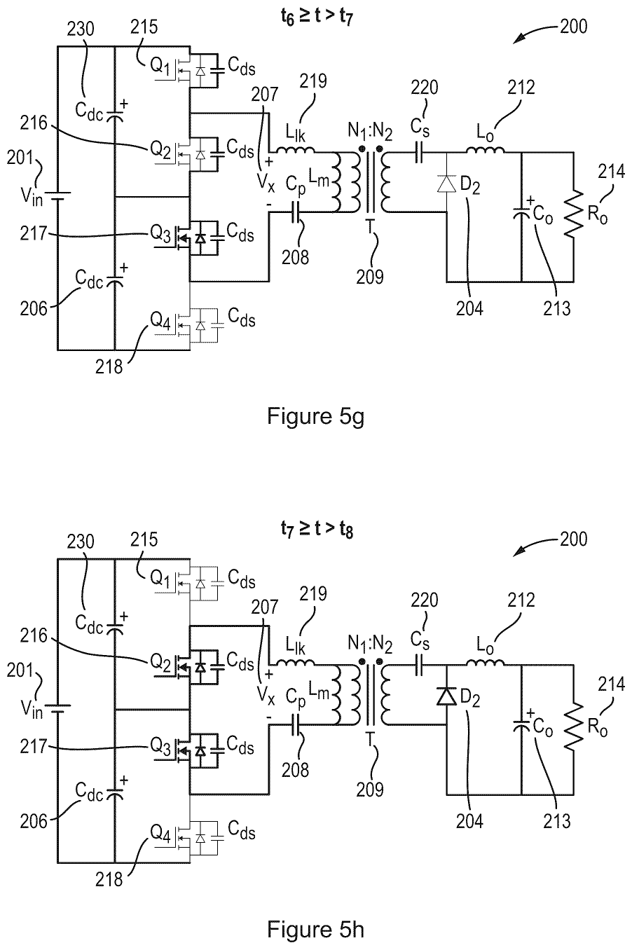

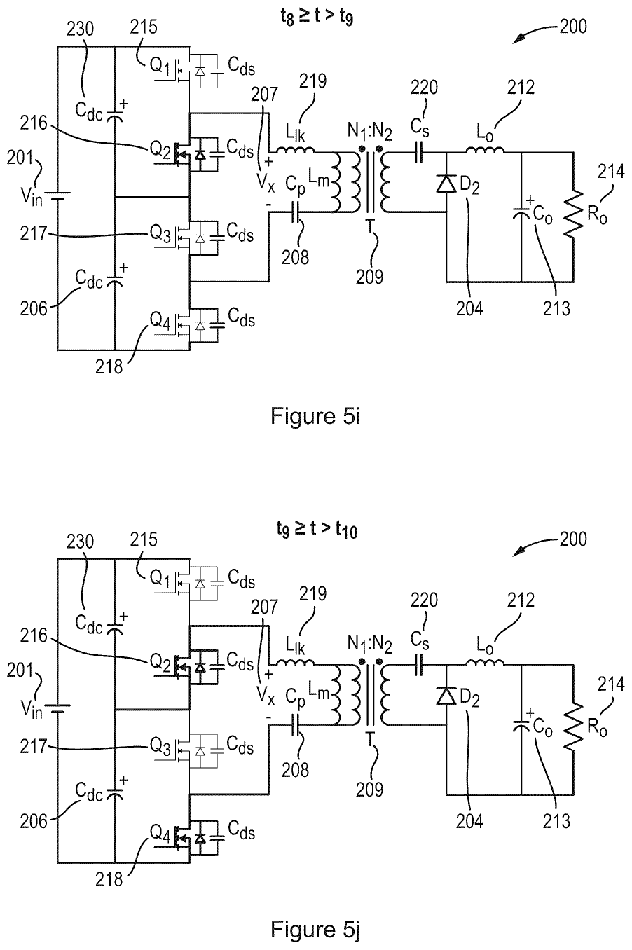

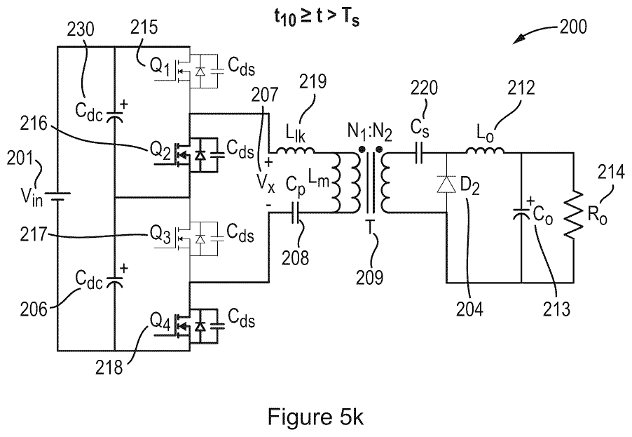

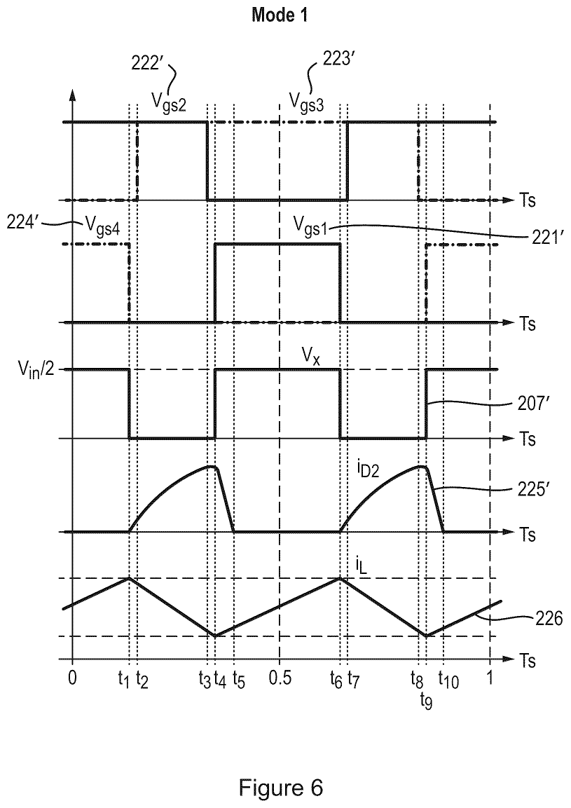

Referring to FIGS. 5a to 5k and FIG. 6, a mode of operation of the three-level zeta asymmetrical half-bridge 200 of FIG. 2 is shown. The shaded elements in FIGS. 5a to 5k indicate no conduction. The mode of operation outlined in FIGS. 5a to 5k and FIG. 6 is referred to as mode 1. In FIGS. 5a to 5k, the input voltage Vᵢₙ 201 is split evenly between a first capacitor 206 and a second capacitor 230. The voltage of the capacitors 206, 230 corresponds to the input voltages Vᵢₙ/2 203, 228 of FIG. 2.

Referring to FIG. 6, waveforms are shown between times t₀ and Tₛ for mode 1 operation, as described in FIGS. 5a to 5k, of the three-level zeta asymmetrical half-bridge 200 of FIG. 2. The waveforms shown represent the gate-source voltage 221′ of the switching element Q₁ 215; the gate-source voltage 222′ of the switching element Q₂ 216; the gate-source voltage 223′ of the switching element Q₃ 217; the gate-source voltage 224′ of the switching element Q₄ 218; the tank voltage Vₓ 207′; the current 225′ through the diode D₂ 204; and the current 226′ through the inductor Lₒ 212. The current 226″ is filtered by the capacitor Cₒ 213 such that, ideally, a constant current is provided to the load Rₒ.

Between times to and t₁, as shown in FIG. 5a and FIG. 6, the tank voltage Vₓ 207′ is equal to half the input voltage Vᵢₙ/2. The tank voltage Vₓ 207′ minus V_{cp}, the voltage across the primary resonant capacitance Cₚ 208, is applied to the primary winding of the transformer 209. The output is charged by the secondary winding of the transformer 209 and the secondary resonant capacitance Cₛ. At time t₁, the switching element Q₄ 218 is turned off, thus starting the dead-time period to ensure zero voltage switching operation.

Between times t₁ and t₂, as shown in FIG. 5b and FIG. 6, the resonant current though the transformer Lₗₖ 219 starts to charge the drain source capacitance of the switching element Q₄ 218 towards half the input voltage Vᵢₙ/2; and discharge the drain source capacitance of the switching element Q₃ 217 to zero. Before time t₂, the voltage 223′ over the switching element Q₃ 217 will reach zero, and its body diode will start conducting, thus clamping the switching element Q₄ 218 at half the input voltage Vᵢₙ/2. At time t₂ the switching element Q₃ 217 switches on, again using zero voltage switching.

Between times t₂ and t₃, as shown in FIG. 5c and FIG. 6, the tank voltage Vₓ 207′ is equal to zero. The voltage applied to the primary winding of the transformer is the tank voltage Vₓ 207′ minus V_{cp}, the voltage across the primary resonant capacitance Cₚ 208. The current 225′ through the diode D₂ 204 increases as the inductor Lₒ 212 and the capacitor Cₒ 213 supply energy to the load Rₒ 214. This time interval ends when the switching element Q₂ 216 is switched off at time t₃.

Between times t₃ and t₄, as shown in FIG. 5d and FIG. 6, the resonant current though the transformer Lₗₖ 219 starts to charge the drain source capacitance of the switching element Q₂ 216 towards half the input voltage Vᵢₙ/2; and discharge the drain source capacitance of the switching element Q₁ 215 to zero. Before time t₄, the voltage 221′ over the switching element Q₁ 215 will reach zero and its body diode will start conducting, thus clamping the switching element Q₂ 216 at half the input voltage Vᵢₙ/2. At time t₄, the switching element Q₁ switches on, using zero voltage switching.

Between times t₄ and t₅, as shown in FIG. 5e and FIG. 6, the tank voltage Vₓ 207′ is equal to half the input voltage Vᵢₙ/2. The voltage applied to the primary winding of the transformer 209 is the tank voltage Vₓ 207′ minus the voltage V_{cp}, the voltage across the primary resonant capacitance Cₚ 208. The current 225′ through D₂ 204 starts to decrease. At time t₅, the current 225″ through the diode D₂ 204 is zero and so the diode D₂ 204 is blocked.

Between times t₅ and t₆, as shown in FIG. 5f and FIG. 6, the output is still charged by the secondary winding of the transformer 209 and the secondary resonant capacitance Cₛ 220. At time to, the switching element Q₁ 215 is turned off, thus starting the dead-time period to ensure zero voltage switching operation.

Between times t₆ and t₇, as shown in FIG. 5g and FIG. 6, the resonant current though the transformer Lₗₖ 219 starts to charge the drain source capacitance of the switching element Q₁ 215 towards half the input voltage Vᵢₙ/2; and discharge the drain source capacitance of the switching element Q₂ 216 to zero. Before time t₇, the voltage 222′ over the switching element Q₂ 216 will reach zero, and its body diode will start conducting, thus clamping the switching element Q₁ 215 at half the input voltage Vᵢₙ/2. At time t the switching element Q₂ 216 switches on using zero voltage switching.

The circuit state at time to shown in FIG. 5g is approximately equivalent to the circuit state at time t₁ as shown in FIG. 5a. The key difference is that the first pair of switching elements Q₁ 215 and Q₂ at time to are now in a state equivalent to the second pair of switching elements Q₃ and Q₄ at time t₁ and vice-versa. FIGS. 5h to 5k are hence analogous to FIGS. 5b to 5e and therefore will not be discussed in detail.

As explained above, the tank voltage Vₓ 207′ in FIG. 6, mode 1 operation, can be seen to be switching at twice the frequency as the tank voltage Vₓ 207 in FIG. 4, mode 3 operation, and with half the amplitude. This is as a result of the first pair of switching elements Q₁ 215 and Q₂ 216 operating out of phase with the second pair of switching elements Q₃ 217 and Q₄ 218. The tank voltage Vₓ 207′ in mode 1 operation alternates between zero and half the input voltage Vᵢₙ/2, rather than alternating between zero and the input voltage Vᵢₙ as per mode 1. If the input voltage were, however, to be split unequally between each pair of switches, the tank voltage Vₓ 207′ would instead alternate in a sequence between zero, the first voltage 203, zero and the second voltage 228.

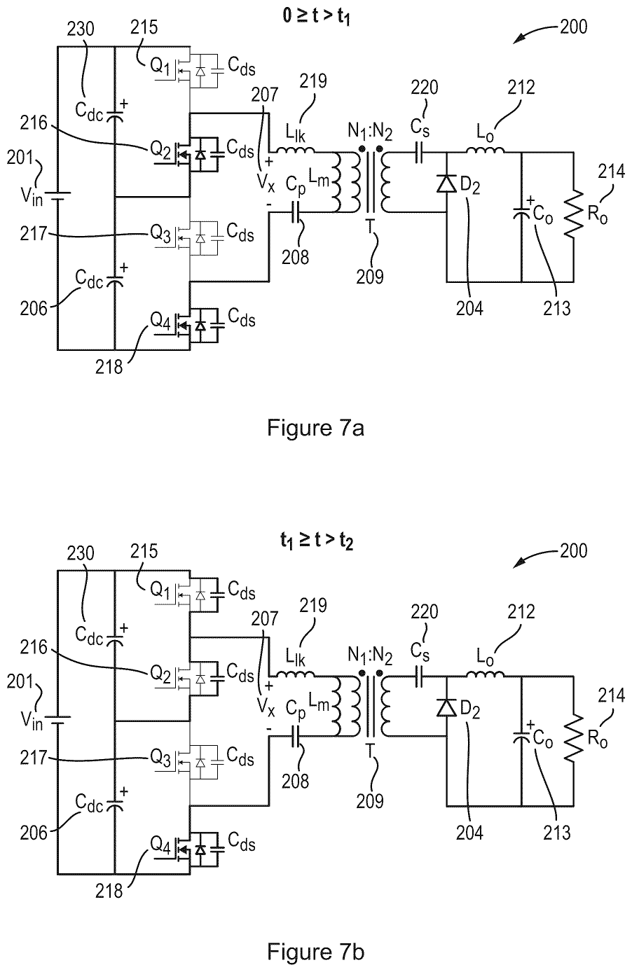

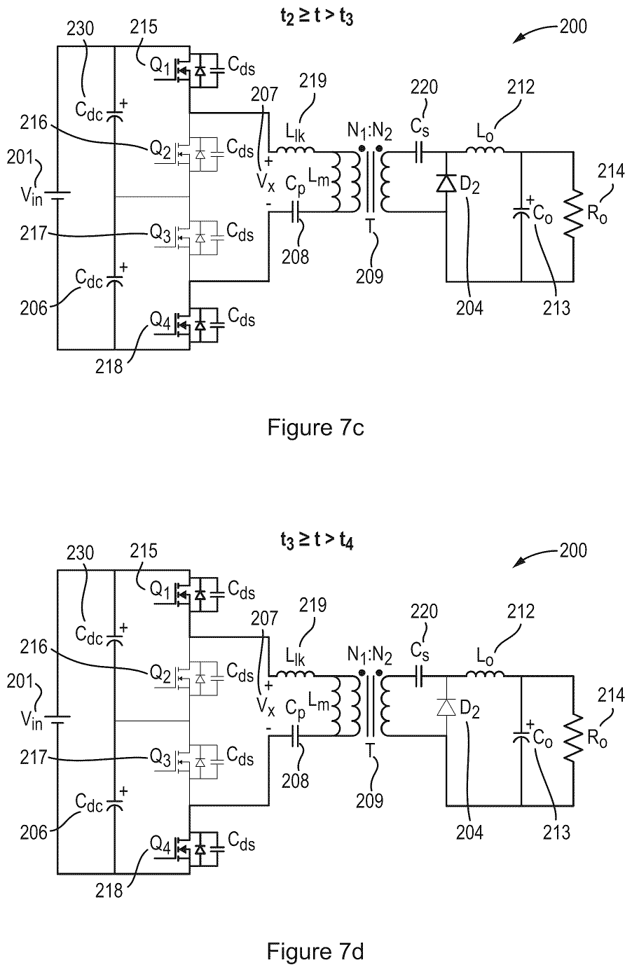

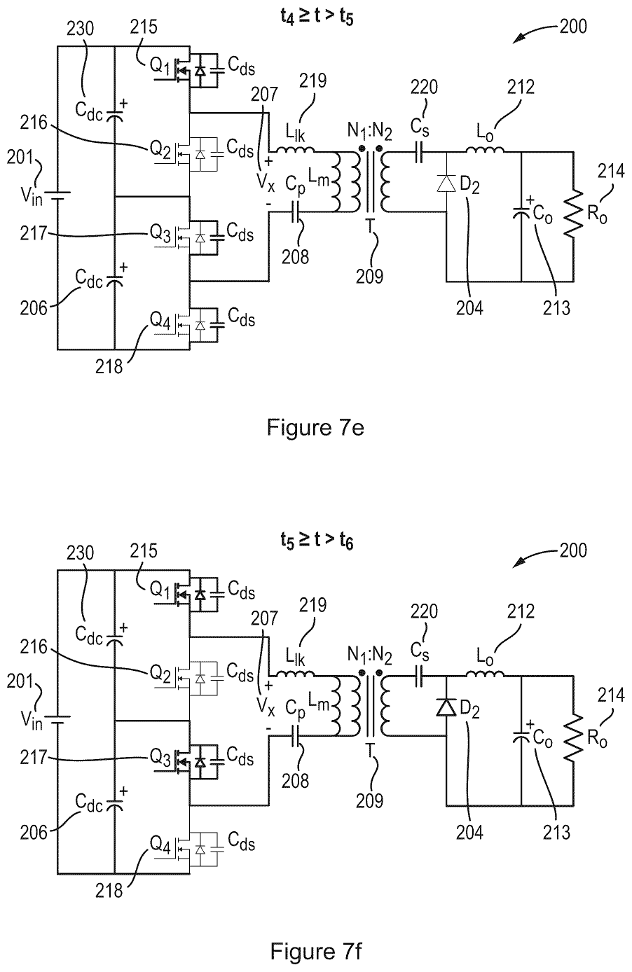

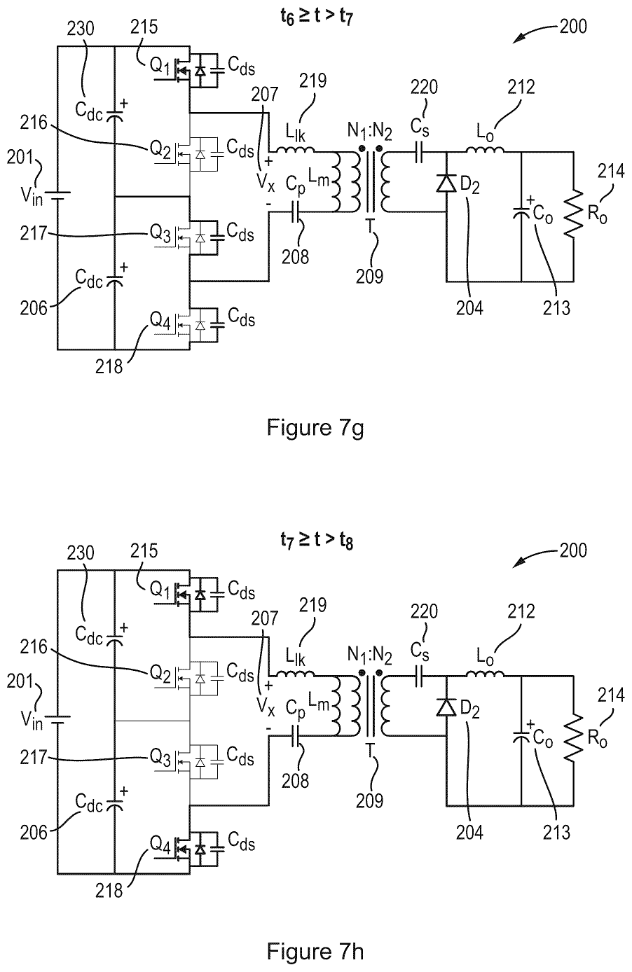

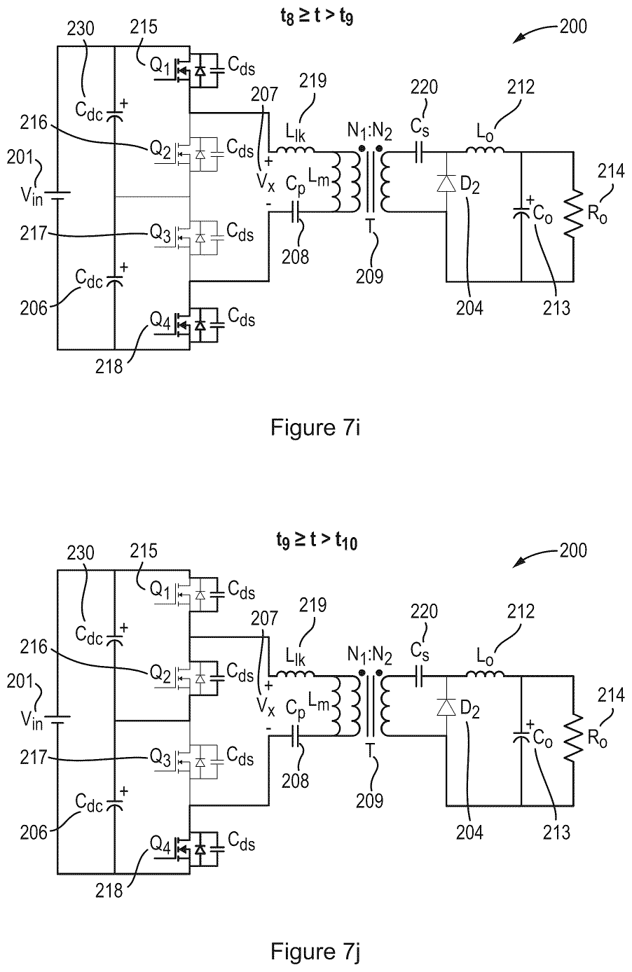

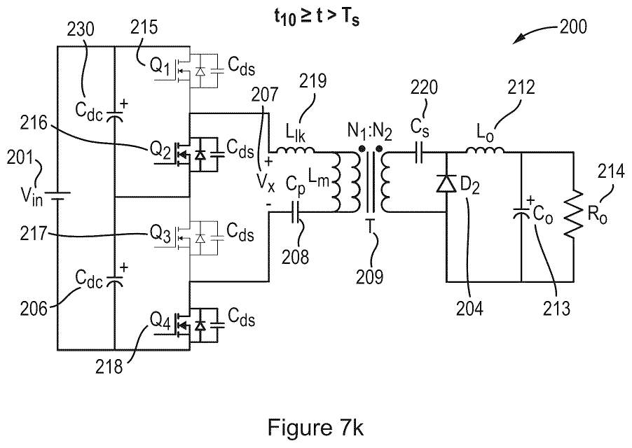

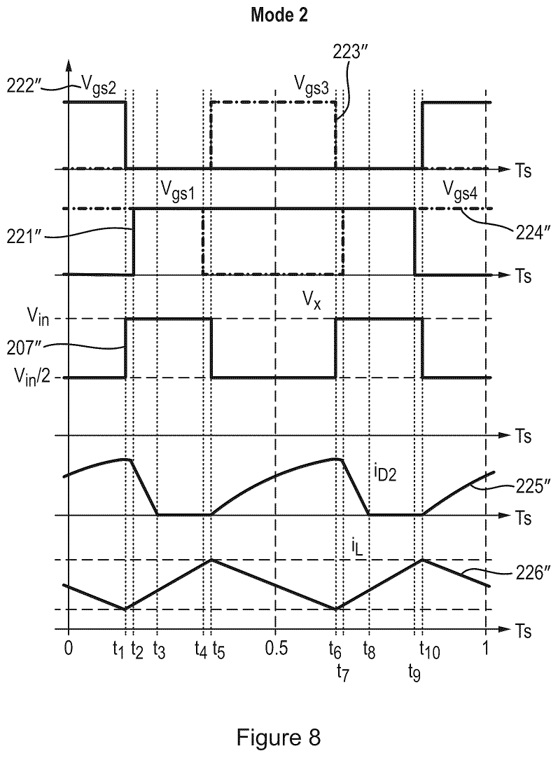

Referring to FIGS. 7a to 7k and FIG. 8, a mode of operation of the three-level zeta asymmetrical half-bridge 200 of FIG. 2 is shown. The shaded elements in FIGS. 7a to 7k indicate no conduction. The mode of operation outlined in FIGS. 7a to 7k and FIG. 8 is referred to as mode 2. In FIGS. 7a to 7k, the input voltage Vᵢₙ 201 is split evenly between a first capacitor 206 and a second capacitor 230. The voltage of the capacitors 206, 230 corresponds to the input voltages Vᵢₙ/2 203, 228 of FIG. 2.

Referring to FIG. 8, waveforms are shown between times to and Tₛ for mode 2 operation, as described in FIGS. 7a to 7k, of the three-level zeta asymmetrical half-bridge 200 of FIG. 2. The waveforms shown represent the gate-source voltage 221″ of the switching element Q₁ 215; the gate-source voltage 222″ of the switching element Q₂ 216; the gate-source voltage 223″ of the switching element Q₃ 217; the gate-source voltage 224″ of the switching element Q₄ 218; the tank voltage Vₓ 207″; the current 225″ through the diode D₂ 204; and the current 226″ through the inductor Lₒ 212. The current 226″ is filtered by the capacitor Cₒ 213 such that, ideally, a constant current is provided to the load Rₒ.

Between times to and t₁, as shown in FIG. 7a and FIG. 8, the tank voltage Vₓ 207″ is equal to half the input voltage Vᵢₙ/2. The voltage applied to the primary winding of the transformer is the tank voltage Vₓ 207″ minus V_{cp}, the voltage across the primary resonant capacitance Cₚ 208. The current 225″ through the diode D₂ 204 increases as the inductor Lₒ 212 and the capacitor Cₒ 213 supply energy to the load Rₒ 214. This time interval ends when the switching element Q₂ 216 is switched off at time t₁.

Between times t₁ and t₂, as shown in FIG. 7b and FIG. 8, the resonant current though the transformer Lₗₖ 219 starts to charge the drain source capacitance of the switching element Q₂ 216 towards half the input voltage Vᵢₙ/2; and discharge the drain source capacitance of the switching element Q₁ 215 to zero. Before time t₂, the voltage 221″ over the switching element Q₁ 215 will reach zero and its body diode will start conducting, thus clamping Q₂ 216 at half the input voltage Vᵢₙ/2. At time t₂, the switching element Q₁ switches on, using zero voltage switching.

Between times t₂ and t₃, as shown in FIG. 7c and FIG. 8, the tank voltage Vₓ 207″ is equal to the input voltage Vᵢₙ. The voltage applied to the primary winding of the transformer 209 is the tank voltage Vₓ 207″ minus the voltage V_{cp}, the voltage across the primary resonant capacitance Cₚ 208. The current 225″ through the diode D₂ 204 starts to decrease. At time t₃, the current 225″ through the diode D₂ 204 is zero and so the diode D₂ 204 is blocked.

Between times t₃ and t₄, as shown in FIG. 7d and FIG. 8, the output is still charged by the secondary winding of the transformer 209 and the secondary resonant capacitance Cₛ 220. At time t₄, the switching element Q₄ 215 is turned off, thus starting the dead-time period to ensure zero voltage switching operation.

Between times t₄ and t₅, as shown in FIG. 7e and FIG. 8, the resonant current though the transformer Lₗₖ 219 starts to charge the drain source capacitance of the switching element Q₄ 218 towards half the input voltage Vᵢₙ/2; and discharge the drain source capacitance of Q₃ 217 to zero. Before time t₅, the voltage 223″ over the switching element Q₃ 217 will reach zero, and its body diode will start conducting, thus clamping the switching element Q₄ 218 at half the input voltage Vᵢₙ/2. At time t₅ the switching element Q₃ 217 switches on using zero voltage switching.

Between times t₅ and t₆, as shown in FIG. 7f and FIG. 8, the tank voltage Vₓ 207″ is equal to half the input voltage Vᵢₙ/2. The voltage applied to the primary winding of the transformer is the tank voltage Vₓ 207″ minus V_{cp}, the voltage across the primary resonant capacitance Cₚ 208. The current 225″ through the diode D₂ 204 increases as the inductor Lₒ 212 and the capacitor Cₒ 213 supply energy to the load Rₒ 214. This time interval ends when the switching element Q₃ 217 is switched off at time t₆.

Between times to and t₇, as shown in FIG. 7g and FIG. 8, the resonant current though the transformer Lₗₖ 219 starts to charge the drain source capacitance of the switching element Q₃ 217 towards half the input voltage Vᵢₙ/2; and discharge the drain source capacitance of the switching element Q₄ 215 to zero. Before time t₇, the voltage 221″ over the switching element Q₄ 218 will reach zero and its body diode will start conducting, thus clamping the switching element Q₃ 217 at half the input voltage Vᵢₙ/2. At time t₇, the switching element Q₄ switches on, using zero voltage switching.

The circuit state at time to shown in FIG. 7g is approximately equivalent to the circuit state at time t₁ as shown in FIG. 7a. The key difference is that the first pair of switching elements Q₁ 215 and Q₂ at time to are now in a state equivalent to the second pair of switching elements Q₃ and Q₄ at time t₁ and vice-versa. FIGS. 7h to 7k are hence analogous to FIGS. 7b to 7e and therefore will not be discussed in detail.

Mode 2 operation is similar to mode 1 operation, however the tank voltage Vₓ 207″ in FIG. 8, mode 2 operation, can be seen to be switching between half the input voltage Vᵢₙ/2 and the input voltage Vᵢₙ, rather than between zero and half the input voltage Vᵢₙ/2. The phase shift between the first pair of switching elements, Q₁ 215 and Q₂ 216, and the second pair of switching elements, Q₃ 217 and Q₄ 218, is different from the phase shift in mode 1 operation.

The best example of this can be seen by comparing FIGS. 5c and 6 with FIGS. 7c and 8. At time t₂, approximately zero voltage is applied to the resonant tank 211 during mode 1 operation in FIGS. 5c and 6. This is because the switching elements Q₂ 216 and Q₃ 217 are on at the same time. This respectively clamps the switching elements Q₁ 215 and Q₄ 218 to half the input voltage Vᵢₙ/2 and therefore no voltage is applied to the resonant tank 211. The inverse happens at time t₂ in FIGS. 7c and 8, resulting in the input voltage Vᵢₙ being applied to the resonant tank 211. Due to the respective phase shifts, the switching elements Q₁ 215 and Q₄ 218 will never be on at the same time during mode 1 operation, and the switching elements Q₂ 216 and Q₃ 217 will never be on at the same time during mode 2 operation.

The tank voltage Vₓ 207″ in mode 2 operation alternates between half the input voltage Vᵢₙ/2 and the input voltage Vᵢₙ in this example. However, if the input voltage were split unequally between each pair of switches, the tank voltage Vₓ 207″ would instead alternate in a sequence between the first voltage 203, the input voltage Vᵢₙ, the second voltage 228, and the input voltage Vᵢₙ.

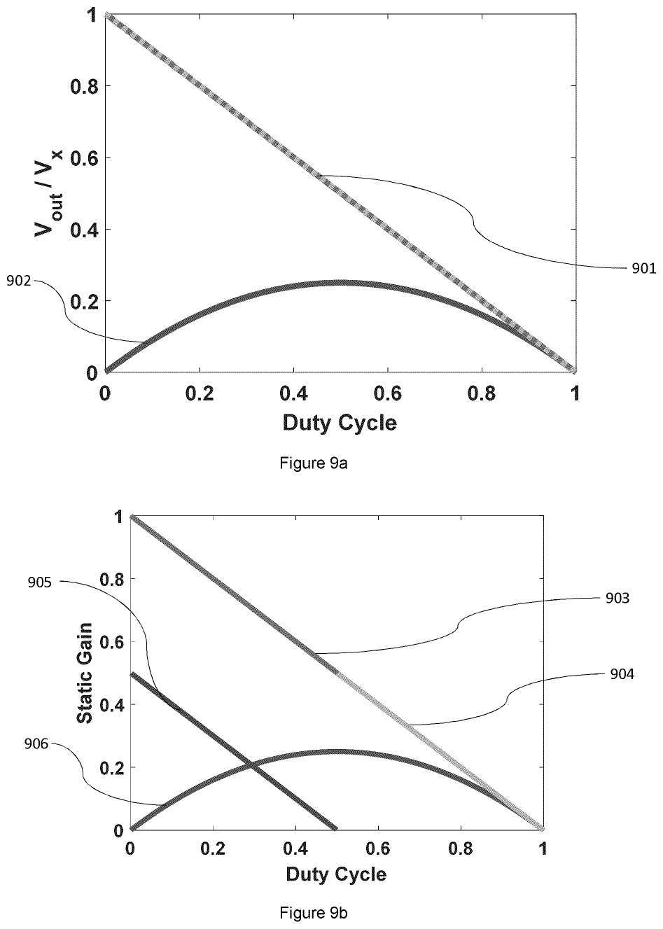

Referring to FIG. 9a, the relationship between tank to output voltage gain and duty cycle 901 is shown for a two-level zeta asymmetrical half-bridge 100 or a three-level zeta asymmetrical half-bridge 200, this relationship is the same for both circuits. Also shown is the relationship between tank to output voltage gain and duty cycle 902 for a traditional asymmetrical half-bridge.

Referring to FIG. 9b, the relationship between static gain and duty cycle 905 is shown for a three-level asymmetrical half-bridge 200 in mode 2 operation, which is a linear relationship as the duty cycle is varied between 0 and 0.5. Also shown is the relationship between static gain and duty cycle 904 for a three-level asymmetrical half-bridge 200 in mode 1, which is a linear relationship as the duty cycle is varied between 0.5 and 1. Also shown is the relationship between static gain and duty cycle 903 for a three-level asymmetrical half-bridge 200 in mode 3 operation, which is the same as for a two-level asymmetrical half-bridge 100, this is a linear relationship as the duty cycle is varied between 0 and 1. When the duty cycle is below 0.5, the static gain 903 of a three-level zeta asymmetrical half bridge 200 in mode 3 operation, or a two-level zeta asymmetrical half-bridge 100, is higher than the static gain 905 of a three-level zeta asymmetrical half bridge 200 in mode 2 operation. When the duty cycle is above 0.5, the static gain 903 of a three-level zeta-asymmetrical half bridge in mode 3 operation, or a two-level zeta asymmetrical half-bridge 100, is the same as the static gain 904 of a three-level zeta asymmetrical half bridge 200 in mode 1 operation; hence 903 overlaps with 904 along the length of 904 in FIG. 9b. Finally, the relationship between static gain and duty cycle 906 is shown for a traditional asymmetrical half-bridge.

Referring to FIGS. 9a and 9b, it can be seen that both the two-level zeta asymmetrical half-bridge 100 and the three-level zeta asymmetrical half-bridge 200 have a linear relationship between duty cycle and tank to output voltage gain 901; and a linear relationship between duty cycle and static gain 903, 904, 905. Whereas the tank to output voltage gain 902 and the static gain 906 of a traditional asymmetrical half-bridge operating at the same switching frequency has a non-linear, quadratic, relationship with duty cycle. This provides various benefits in the control of a zeta asymmetrical half-bridge over a traditional asymmetrical half-bridge, as the linear relationship is much simpler to account for than the non-linear relationship.

Additionally, FIG. 9b shows that the static gain 903, 904, 905 of a three-level zeta asymmetrical half-bridge 200 is different depending on which of the 3 modes of operation that the device operates in. This provides greater flexibility in the configuration of the device when compared with a two-level zeta asymmetrical half-bridge 100.

FIG. 9b shows that for a given 1:1 transformer, and a given switching frequency of the switching elements, modes 1 and 2 will have a linear gain 904, 905 between zero and 0.5. This may be lower than the gain 903 during mode 3 operation, which is the same as the gain 903 of an equivalent two-level zeta asymmetrical half-bridge 100, which is between zero and 1. This again highlights the advantage that operation of a three-level zeta asymmetrical half-bridge 200 in modes 1 and 2 in step down applications requires a smaller transformer than an equivalent two-level zeta asymmetrical half-bridge 100, and/or may operate with a lower switching frequency, due to the lower linear gain 904, 905.

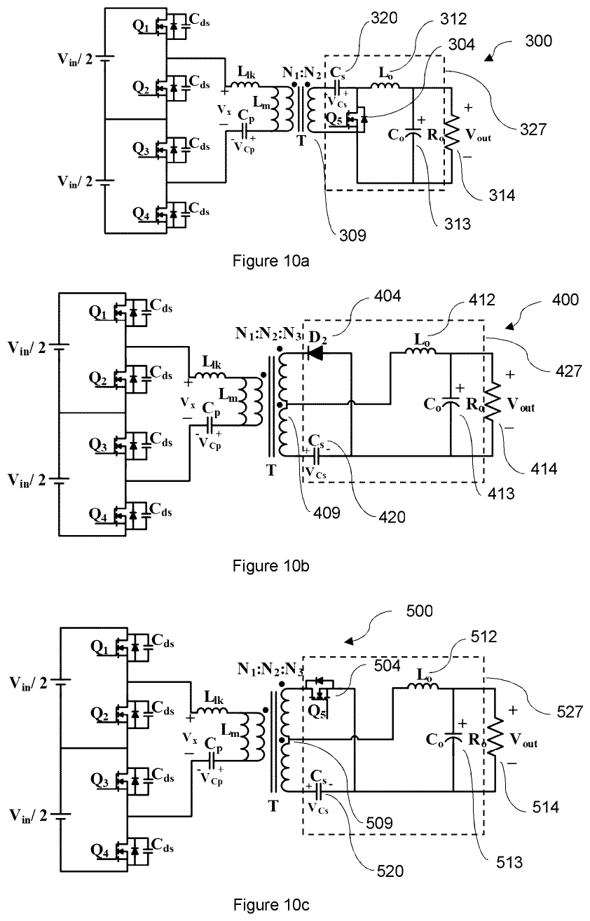

Referring to FIG. 10a, a variant 300 of the three-level zeta asymmetrical half-bridge 200 of FIG. 2 is shown, wherein the diode D₂ 204 is replaced with a rectifying switching element Q₅ 304, which in this example is a MOSFET, for active rectification; as opposed to the passive rectification used in the three-level zeta asymmetrical half bridge 200. This is an example of a variation of the zeta converter 227 used in the three-level zeta asymmetrical half-bridge 200 of FIG. 2. Active rectification has lower conduction losses than passive rectification, this is particularly useful for applications with a high current load, which often correspond with low voltage applications.

In this example, the zeta converter 327 comprises: a MOSFET Q₅ 304 in series with the secondary winding of the transformer 309; an output inductor Lₒ 312 in series with a secondary resonant capacitance Cₛ 320, and in parallel with MOSFET Q₅ 304. The zeta converter 327 further comprises an output capacitor C_{O} 313 in series with the output inductor L_{O} 312. In this example, the DC output voltage Vₒᵤₜ 314 is applied to a load R_{O} 314 in parallel with the output capacitor C_{O} 313 and in series with the output inductor L_{O} 312.

Referring to FIG. 10b, another variant 400 of the three-level zeta asymmetrical half-bridge 200 of FIG. 2 is shown with a tapped transformer 409. This is another example of a variation of the zeta converter 227 used in the three-level zeta asymmetrical half-bridge 200 of FIG. 2. A Tapped transformer gives an extra degree of freedom to optimize the secondary side conduction of the secondary resonant capacitance Cₛ 420 and the diode D₂ 404 towards loss and/or size reduction. This is achieved by varying the ratio of turns between each of the output windings of the tapped transformer 409.

In this example, the zeta (427) converter comprises: a rectifying diode D₂ 404 in series with the secondary winding of the tapped transformer 409; an output inductor L_{O} 412 connected part-way along the secondary winding of the transformer 409; and an output capacitor C_{O} 413 in series with the output inductor L_{O} 412. In this example, the DC output voltage Vₒᵤₜ 414 is applied to a load R_{O} 414 in parallel with the output capacitor C_{O} 413 and in series with the output inductor L_{O} 412. In this example, the zeta converter 427 further comprises a secondary resonant capacitance C_{S} 420 in series with each of the secondary winding of the transformer 409, the rectifying diode D₂ 404, and the output inductor L_{O} 412.

Referring to FIG. 10c, a further variant 500 of the three-level zeta asymmetrical half-bridge 200 of FIG. 2 is shown which has both a rectifying switching element Q₅ 504, which in this example is a MOSFET, for active rectification, and a tapped transformer 509. This is a further example of a variation of the zeta converter 227 used in the three-level zeta asymmetrical half-bridge 200 of FIG. 2 and has the advantages of both the active rectification and trapped transformed topologies.

In this example, the zeta converter 527 comprises: a MOSFET Q₅ 504 in series with the secondary winding of the tapped transformer 509; an output inductor L_{O} 512 connected part-way along the secondary winding of the transformer 509; an output capacitor C_{O} 513 in series with the output inductor L_{O} 512. In this example, the DC output voltage Vₒᵤₜ 514 is applied to a load R_{O} 514 in parallel with the output capacitor C_{O} 513 and in series with the output inductor L_{O} 512. In this example, the zeta converter 527 further comprises a secondary resonant capacitance C_{S} 520 in series with each of the secondary winding of the transformer 509, the MOSFET Q₅ 504, and the output inductor L_{O} 512. One skilled in the art will appreciate that the three-level zeta asymmetrical half-bridge 200; 300; 400; 500 may be useful for step down DC voltage conversion applications due to the benefits listed above, for example the reduction in the size of the transformer and/or the reduction in switching frequency relative to an equivalent two-level zeta-asymmetrical half-bridge. In addition, by splitting the input voltage 201 into a first input voltage 203 and a second input voltage 228, therefore reducing the size of the voltage applied to the components of the circuit, higher input voltages may be applied to the circuit and/or smaller components may be used. In particular, the three-level zeta asymmetrical half-bridge 200; 300; 400; 500 is useful in stepping down voltages in the region of 400V to 3 kV to a voltage of approximately 28V. Therefore, a three-level zeta asymmetrical half-bridge 200; 300; 400; 500 would be particularly useful in aircrafts where DC power distribution is used. Here, the high voltages may be used in the aircraft's propulsion systems, while the lower voltages may be used elsewhere in the aircraft. Galvanic isolation between the high voltage load is particularly important to ensure proper grounding protection and safety.

The three-level zeta asymmetrical half-bridge 200; 300; 400; 500 may also be useful when the high input voltage has a wide variation, for example a variation between 400v to 750V, as the three-level zeta asymmetrical half-bridge 200; 300; 400; 500 will be able to operate at a fixed switching frequency, despite the high voltage variation by changing the duty cycle. This presents an advantage over a traditional LLC converter for this application which would require a high variation of switching frequency.

1. A three-level zeta asymmetrical half-bridge for converting a DC input voltage into a DC output voltage comprising:
an asymmetrical half-bridge, comprising a first pair of switching elements, and a second pair of switching elements in series with the first pair of switching elements;
a resonant tank in parallel with one switching element from each pair of switching elements, the resonant tank comprising a magnetising inductance of a primary winding of a transformer, a resonant inductance and a primary resonant capacitance; and
a zeta converter connected to a secondary winding of the transformer;
wherein a first portion of the DC input voltage is applied in parallel with the first pair of switching elements, and a second portion of the DC input voltage is applied in parallel with the second pair of switching elements;
wherein each pair of switching elements is arranged to operate in a sequence to selectively connect and disconnect the resonant tank to the respective first or second portion of the DC input voltage, such that a voltage of the resonant tank alternates between a low voltage and a high voltage;
wherein the resonant tank is arranged to filter out a DC component of the voltage of the resonant tank and output a filtered resonant tank voltage to the primary winding of the transformer; and
wherein the zeta converter is arranged to rectify the output of the secondary winding of the transformer to output the DC output voltage.

2. The three-level zeta asymmetrical half-bridge of claim 1 wherein the switching elements comprise a switch, diode and capacitance in parallel; and optionally wherein
the switching elements are each arranged to switch on when the voltage across the respective switching element is zero.

3. The three-level zeta asymmetrical half-bridge of claim 1 wherein the first pair of switching elements and the second pair of switching elements are arranged to operate in phase to alternate the voltage applied to the resonant tank between the DC input voltage and ground.

4. The three-level zeta asymmetrical half-bridge of claim 1 wherein the first pair of switching elements and the second pair of switching elements are arranged to operate out of phase.

5. The three-level zeta asymmetrical half-bridge of claim 1 wherein the first portion and the second portion of the DC input voltage is equal to half the DC input voltage; and optionally
wherein the DC input voltage is split across a first capacitor, across which the first portion of the DC input voltage is applied, and a second capacitor, across which the second portion of the DC input voltage is applied;
wherein the first capacitor is in series with the second capacitor.

6. The three-level zeta asymmetrical half-bridge of claim 4 wherein the first pair of switching elements and the second pair of switching elements are arranged to operate out of phase to alternate the voltage applied to the resonant tank between half the DC input voltage and ground.

7. The three-level zeta asymmetrical half-bridge of claim 4 wherein the first pair of switching elements and the second pair of switching elements are arranged to operate out of phase to alternate the voltage applied to the resonant tank between the DC input voltage and half the DC input voltage.

8. The three-level zeta asymmetrical half-bridge of claim 1 wherein the zeta converter comprises:
a secondary resonant capacitance in series with the secondary winding of the transformer;
a rectifying diode in series with the secondary winding of the transformer;
an output inductor in series with the secondary resonant capacitance and in parallel with the rectifying diode;
an output capacitor in series with the output inductor; and
wherein the DC output voltage is applied to a load in parallel with the output capacitor and in series with the output inductor.

9. The three-level zeta asymmetrical half-bridge of claim 1 wherein the zeta converter comprises:
a rectifying switching element comprising a switch and a diode in parallel, wherein the rectifying switching element is in series with the secondary winding of the transformer;
an output inductor in series with the secondary resonant capacitance and in parallel with the rectifying switching element;
an output capacitor in series with the output inductor; and
wherein the DC output voltage is applied to a load in parallel with the output capacitor and in series with the output inductor; and
optionally wherein the rectifying switching element is a MOSFET with an integrated body diode and switch.

10. The three-level zeta asymmetrical half-bridge of claim 1 wherein:
the transformer is a tapped transformer; and
wherein the zeta converter comprises:
a rectifying diode in series with the secondary winding of the transformer;
an output inductor connected part-way along the secondary winding of the transformer;
an output capacitor in series with the output inductor;
wherein the DC output voltage is applied to a load in parallel with the output capacitor and in series with the output inductor; and
wherein the zeta converter further comprises a secondary resonant capacitance in series with each of the secondary winding of the transformer, the rectifying diode, and the output inductor.

11. The three-level zeta asymmetrical half-bridge of claim 1 wherein:
the transformer is a tapped transformer; and
wherein the zeta converter comprises:
a rectifying switching element comprising a switch and a diode in parallel, wherein the active rectifying switching element is in series with the secondary winding of the transformer;
an output inductor connected part-way along the secondary winding of the transformer;
an output capacitor in series with the output inductor;
wherein the DC output voltage is applied to a load in parallel with the output capacitor and in series with the output inductor; and
wherein the zeta converter further comprises a secondary resonant capacitance in series with each of the secondary winding of the transformer, the rectifying switching element, and the output inductor; and
optionally wherein the rectifying switching element is a MOSFET with an integrated body diode and switch.

12. The three-level zeta asymmetrical half-bridge of claim 1 wherein the primary resonant inductance is the leakage inductance of the primary winding of the transformer.

13. The three-level zeta asymmetrical half-bridge of claim 1 wherein the switching elements are arranged to alternate the voltage of the resonant tank between the low voltage and the high voltage at a fixed frequency; and optionally
wherein a proportion of time that the voltage applied to the resonant tank is a high voltage is varied.

14. The three-level zeta asymmetrical half-bridge according to claim 1 wherein the switching elements are arranged to operate to generate a square wave to the resonant tank such that the voltage of the resonant tank is a square wave.

15. A method of operating a three-level zeta asymmetrical half-bridge to convert a DC input voltage into a DC output voltage, wherein the three-level zeta asymmetrical half-bridge comprises:
an asymmetrical half-bridge, comprising a first pair of switching elements, and a second pair of switching elements in series with the first pair of switching elements;
a resonant tank in parallel with one switching element from each pair of switching elements, the resonant tank comprising a magnetising inductance of a primary winding of a transformer, a resonant inductance and a primary resonant capacitance; and
a zeta converter connected to a secondary winding of the transformer;
the method comprising:
applying a first portion of the DC input voltage in parallel with the first pair of switching elements;
applying a second portion of the DC input voltage in parallel with the second pair of switching elements;
operating each pair of switching elements in a sequence to selectively connect and disconnect the resonant tank to the respective first or second portion of the DC input voltage, such that a voltage of the resonant tank alternates between a low voltage and a high voltage;
the resonant tank filtering out a DC component of the voltage of the resonant tank and outputting a filtered resonant tank voltage to the primary winding of the transformer; and
the zeta converter rectifying the output of the secondary winding of the transformer to output the DC output voltage.
